(19) United States
(12) Patent Application Publication
(10) Pub. No.: US 2022/0261704 A1
(43) Pub. Date: Aug. 18, 2022

(54) INFORMATION PROCESSING DEVICE, STORAGE MEDIUM, INFORMATION PROCESSING SYSTEM, AND OPERATION METHOD FOR INFORMATION PROCESSING DEVICE

(71) Applicant: TOYOTA JIDOSHA KABUSHIKI KAISHA, Toyota-shi (JP)

(72) Inventors: Yuka TAKIGUCHI, Toyota-shi (JP); Tetsushi OKAMOTO, Miyoshi-shi (JP); Hirokazu KOBAYASHI, Toyota-shi (JP); Minoru NAKADORI, Toyota-shi (JP); Daiki KANEICHI, Tokyo (JP)

(73) Assignee: TOYOTA JIDOSHA KABUSHIKI KAISHA, Toyota-shi (JP)

(21) Appl. No.: 17/592,787

(22) Filed: Feb. 4, 2022

(30) Foreign Application Priority Data
Feb. 17, 2021 (JP) 2021-023699

(51) Int. Cl. G06Q 10/02; H04W 4/40

(52) U.S. Cl. CPC G06Q 10/02; H04W 4/40

(57) ABSTRACT

An information processing device includes a communication module and a processor. The processor is configured to send and receive information to and from another device via the communication module, and, in a case where an available time of a second vehicle stored in a storage location is equal to or longer than a reference time when an available time of a first vehicle waiting in an on-demand waiting area becomes shorter than the reference time, send a first command to the first vehicle such that the first vehicle moves to the storage location and send a second command to the second vehicle such that the second vehicle moves to the on-demand waiting area.

### CROSS-REFERENCE TO RELATED APPLICATION

This application claims priority to Japanese Patent Application No. 2021-023699 filed on Feb. 17, 2021, incorporated herein by reference in its entirety.

### BACKGROUND

### 1. Technical Field

The present disclosure relates to information processing devices, storage media, information processing systems, and operation methods for the information processing device.

### 2. Description of Related Art

As car sharing services are becoming more widespread, various technologies for managing vehicles that are used for the car sharing services have been proposed.

For example, Japanese Unexamined Patent Application Publication No. 2017-102553 (JP 2017-102553 A) discloses a vehicle management system capable of rationally sharing vehicles between a car sharing service and a car rental service by combining vehicle management for the car sharing service and vehicle management for the car rental service.

### SUMMARY

There is room for improvement in a vehicle management method for on-demand use in which a user requests a shared car waiting in a waiting location and uses it on the spot.

Means for improving the efficiency of management of vehicles that are provided for on-demand use in a car sharing service is disclosed below.

A first aspect of the present disclosure relates to an information processing device. The information processing device includes a communication module and a processor. The processor is configured to send and receive information to and from another device via the communication module, and, in a case where an available time of a second vehicle stored in a storage location is equal to or longer than a reference time when an available time of a first vehicle waiting in an on-demand waiting area becomes shorter than the reference time, send a first command to the first vehicle such that the first vehicle moves to the storage location and send a second command to the second vehicle such that the second vehicle moves to the on-demand waiting area.

A second aspect of the present disclosure relates to a storage medium. The storage medium is a non-transitory storage medium readable by a computer and may store a program that is executed by a processor to implement the information processing device in the first aspect.

A third aspect of the present disclosure relates to an information processing system. The information processing system may include the information processing device, the first vehicle and the second vehicle in the first aspect.

A fourth aspect of the present disclosure relates to an operation method for an information processing device including a communication module and a processor that sends and receives information to and from another device via the communication module. The operation method includes, in a case where an available time of a second vehicle stored in a storage location is equal to or longer than a reference time when an available time of a first vehicle waiting in an on-demand waiting area becomes shorter than the reference time, sending a first command from the processor to the first vehicle such that the first vehicle moves to the storage location and sending a second command from the processor to the second vehicle such that the second vehicle moves to the on-demand waiting area.

According to the present disclosure, it is possible to improve the efficiency of management of vehicles that are provided for on-demand use in a sharing car service.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 illustrates a configuration example of an information processing system;

FIG. 2 shows an example of parking areas;

FIG. 3 is a block diagram showing a configuration of an information processing device;

FIG. 4 is a block diagram showing a schematic of a terminal device;

FIG. 5 is a block diagram showing a configuration of a vehicle;

FIG. 6 is a flowchart showing an example of an operation procedure of the information processing device for reservation use;

FIG. 7 is a flowchart showing an example of an operation procedure of the information processing device for on-demand use;

FIG. 8 shows an example of replenishment with a vehicle that is provided for on-demand use;

FIG. 9 is a flowchart showing an example of an operation procedure that is performed by the information processing device when replenishing with a vehicle that is provided for on-demand use;

FIG. 10 is a flowchart showing an example of an operation procedure that is performed by the information processing device when selecting an available model and a vehicle;

FIG. 11 is an example of a reservation table showing the reservation status of models and vehicles;

FIG. 12 is an example of a reservation table showing the reservation status of models and vehicles;

FIG. 13 is an example of a reservation table showing the reservation status of models and vehicles;

FIG. 14 is an example of a reservation table showing the reservation status of a model and vehicles;

FIG. 15 is an example of a reservation table showing the reservation status of a model and vehicles;

FIG. 16A is a flowchart showing an example of an operation procedure that is performed by the information processing device when switching a vehicle that is provided for on-demand use;

FIG. 16B is a flowchart showing an example of an operation procedure that is performed by the information processing device when switching a vehicle that is provided for on-demand use;

FIG. 17 is an example of a reservation table showing the reservation status of a model and vehicles; and

FIG. 18 is an example of a reservation table showing the reservation status of models and vehicles.

### DETAILED DESCRIPTION OF EMBODIMENTS

Hereinafter, an embodiment of the present disclosure will be described below with reference to the drawings.

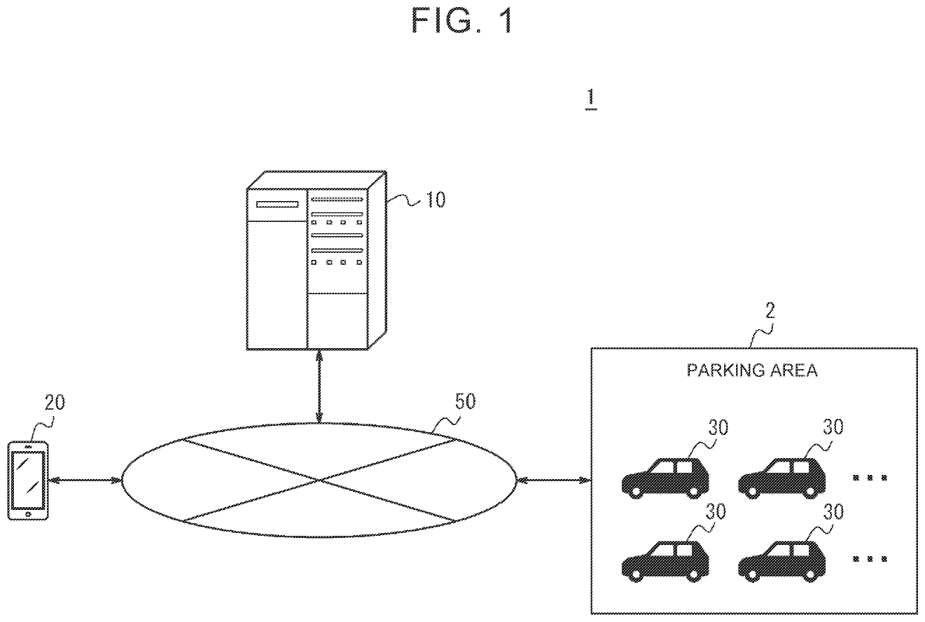

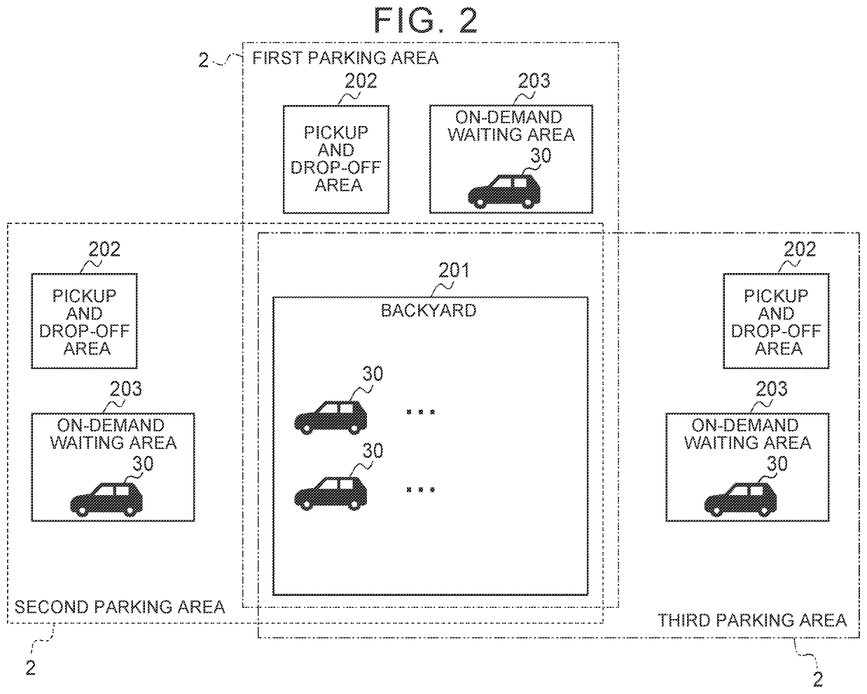

FIG. 1 shows a configuration of an information processing system 1 according to an embodiment. The information processing system 1 is a system that provides a car sharing service to users by using a vehicle 30. FIG. 2 illustrates parking areas 2 in which the vehicle 30 is stored or wait. The configuration and overview of the information processing system 1 will be described with reference to FIGS. 1 and 2.

The information processing system 1 includes one or more information processing devices 10, one or more terminal devices 20, and one or more vehicles 30. The one or more information processing devices 10, the one or more terminal devices 20, and the one or more vehicles 30 are connected to each other via a network 50 so that they can communicate with each other.

The information processing device 10 is, for example, a computer configured to function as a server, such as a general-purpose personal computer (personal computer). The information processing device 10 monitors the status of the vehicle 30 in the parking area 2 based on, for example, data acquired from a camera, sensor, etc. installed in the parking area 2. The information processing device 10 communicates with the terminal device 20 and the vehicle 30 via the network 50, and manages the vehicle 30 that is used for the car sharing service.

The terminal device 20 is a terminal device that is used by a user who uses the car sharing service. The terminal device 20 is, for example, a smartphone or a tablet.

The vehicle 30 is a vehicle that is used for the car sharing service. For example, the vehicle 30 is any type of automobile such as gasoline vehicle, diesel vehicle, hybrid vehicle (HV), plug-in hybrid vehicle (PHV), electric vehicle (EV), or fuel cell vehicle (FCV). The vehicle 30 is a vehicle capable of autonomous driving and having, for example, an automated valet parking (AVP) function. For example, when the user uses the car sharing service, the vehicle 30 can autonomously move to a place where the user picks up the vehicle 30. When the user drops off the vehicle 30, the vehicle 30 can autonomously move to a predetermined position.

The network 50 is a network including, for example, a mobile communication network and the Internet.

FIG. 2 shows an example of three parking areas 2, namely first to third parking areas 2 (hereinafter referred to as the parking areas 2 when the first to third parking areas need not be identified). The parking area 2 is a space where the vehicle 30 not being used by the user is stored or waits. For example, the parking area 2 is provided in the basement of an apartment building in which the user of the car sharing service etc. lives. A plurality of parking areas 2 may overlap each other as shown in the figure, or may be located separately from each other. The parking areas 2 need not necessarily be provided in the basement of the same apartment building. The parking areas 2 may be dispersed in the basements of different apartment buildings or may be provided in sites located about several tens to several hundreds of meters away from each other. Each parking area 2 has one or more backyards 201, one or more pickup and drop-off areas 202, and one or more on-demand waiting areas 203 in a desired layout. Each parking area 2 may have its own backyard 201, pickup and drop-off area 202, and on-demand waiting area 203, or two or more parking areas 2 may share one or more of the following areas: the backyard 201, the pickup and drop-off area 202, and the on-demand waiting area 203. In the example described herein, the three parking areas 2 share the backyard 201, and each of the three parking areas 2 has its own pickup and drop-off area 202 and on-demand waiting area 203.

In the car sharing service provided by the information processing system 1, the user can use the vehicle 30 for both reservation use and on-demand use. Reservation use is the type of use in which the user makes an advance reservation to use the vehicle 30 stored in a storage location in the parking area 2, namely in the backyard 201. The backyard 201 has equipment for servicing the vehicle 30 stored in the backyard 201, such as equipment for charging the battery of the vehicle 30 and equipment for cleaning the vehicle 30. The pickup and drop-off area 202 is a space the user picks up and drops off the vehicle 30 for reservation use. On-demand use is the type of use in which the user goes to the waiting location in the parking area 2 where the vehicle 30 for on-demand use waits, namely the user goes to the on-demand waiting area 203, and then requests the vehicle 30 waiting in the on-demand waiting area 203 and uses the vehicle 30 immediately.

The information processing device 10 manages one or more models of one or more vehicles 30 stored or waiting in each parking area 2. By managing one or more models and one or more vehicles 30 of each model, the information processing device 10 can provide the user with the vehicle 30 of the model that matches the user's purpose by either reservation use or on-demand use. The vehicle 30 is not exclusively used for either reservation use or on-demand use. The vehicle 30 is dynamically assigned to reservation use or on-demand use by the information processing device 10. For example, the information processing device 10 assigns the vehicle 30 not reserved for reservation use to on-demand use and sends a command to that vehicle 30 to move from the backyard 201 to the on-demand waiting area 203, or assigns the vehicle 30 not being used for on-demand use to reservation use and sends a command to that vehicle 30 to move from the on-demand waiting area 203 to the backyard 201.

In the present embodiment, the information processing device 10 selects the model with a longer available time than the other models (hereinafter referred to as the available model) based on the reservation status of each model of a plurality of vehicles 30 stored in the storage location in the parking area 2, that is, the backyard 201. The information processing device 10 then sends a command to the vehicle 30 of the available vehicle model to move to the waiting location for on-demand use in the parking area 2, that is, the on-demand waiting area 203. The information processing device 10 can thus optimally distribute a limited number of vehicles 30 in the parking area 2 to reservation use or on-demand use and reliably secure the vehicle 30 that is provided for on-demand use. Therefore, it is possible to improve the efficiency of management of the vehicles 30 that are provided for on-demand use.

When the user uses the car sharing service by reservation use or on-demand use, the following operation is generally performed.

For reservation use, the user uses the terminal device 20 to send request information for reservation use to the information processing device 10. The request information includes information on a desired model, pickup date and time, scheduled return date and time, and desired pickup location. The user designates a desired location such as the pickup and drop-off area 202 or in front of the user's residence as the pickup location. The information processing device 10 dispatches the vehicle 30 assigned to the reservation use so that the vehicle 30 of the model desired by the user arrives at the pickup location designated by the user at least a predetermined time before the pickup date and time. The vehicle 30 autonomously heads for the pickup location designated by the user in response to a command received from the information processing device 10.

For on-demand use, the user goes to the on-demand waiting area 203, and when there is any vehicle 30 waiting in the on-demand waiting area 203, the user requests on-demand use of that vehicle 30. The user operates the terminal device 20 to send request information for on-demand use to the information processing device 10. The request information includes information on a scheduled return date and time. For on-demand use, the user uses the vehicle 30 waiting in the on-demand waiting area 203 without selecting in advance the model and the pickup location. Information on a pickup date and time is therefore not necessary. A two-dimensional code including information necessary to request on-demand use is attached to the vehicle 30. The user uses the terminal device 20 to take a picture of the two-dimensional code attached to the vehicle 30 waiting in the on-demand waiting area 203. The terminal device 20 sends information included in the two-dimensional code to the information processing device 10. The two-dimensional code includes, for example, identification information identifying the vehicle 30. The information processing device 10 thus identifies and manages the vehicle 30 to be used for on-demand use.

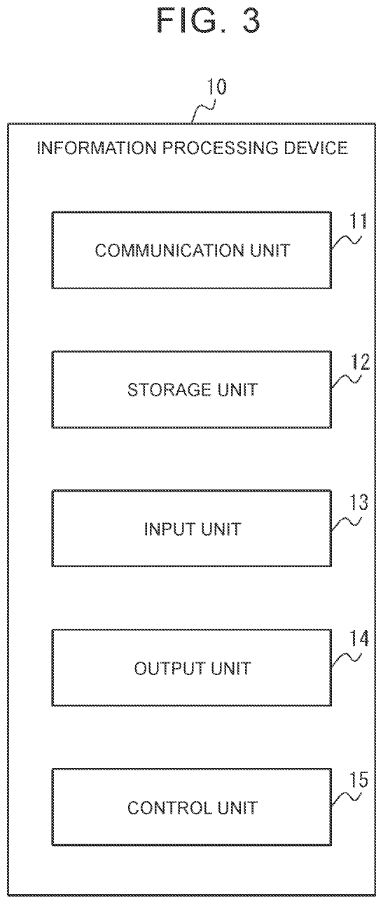

The configuration of the information processing device 10 according to the present embodiment will be described with reference to FIG. 3.

The information processing device 10 includes a communication unit 11, a storage unit 12, an input unit 13, an output unit 14, and a control unit 15.

The communication unit 11 includes a communication module connected to the network 50. For example, the communication unit 11 may include a communication module compatible with a local area network (LAN). In the present embodiment, the information processing device 10 is connected to the network 50 via the communication unit 11. The communication unit 11 sends and receives various kinds of information via the network 50. The communication unit 11 can communicate with the terminal device 20 and the vehicle 30 via the network 50.

For example, the storage unit 12 is, but not limited to, a semiconductor memory, a magnetic memory, or an optical memory. The storage unit 12 may function as, for example, a main storage device, an auxiliary storage device, or a cache memory. The storage unit 12 stores any information to be used for the operation of the information processing device 10. For example, the storage unit 12 may store a system program, an application program, and various kinds of information received by the communication unit 11. The information stored in the storage unit 12 may be updatable with, for example, information received from the network 50 via the communication unit 11. A part of the storage unit 12 may be installed outside the information processing device 10. In that case, the part of the storage unit 12 installed outside the information processing device 10 is connected to the information processing device 10 via, for example, a desired interface.

The input unit 13 includes one or more input interfaces that detect user input and acquire input information based on the user's operation. For example, the input unit 13 includes, but not limited to, a physical key, a capacitive key, a touch screen integrated with a display of the output unit 14, or a microphone that accepts voice input.

The output unit 14 includes one or more output interfaces that output information to notify the user. For example, the output unit 14 includes, but not limited to, a display that outputs information as images or a speaker that outputs information as audio.

The control unit 15 includes one or more processors, one or more dedicated circuits, or a combination thereof. The processor is a general-purpose processor such as central processing unit (CPU) or graphics processing unit (GPU), or a dedicated processor specialized for a specific process. The dedicated circuit is, for example, a field-programmable gate array (FPGA) or an application-specific integrated circuit (ASIC). The control unit 15 performs processes related to the operation of the information processing device 10 while controlling each unit of the information processing device 10.

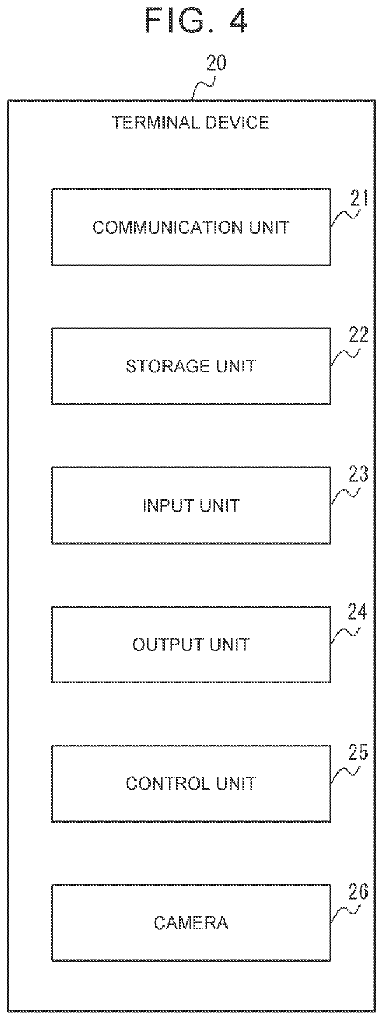

The configuration of the terminal device 20 according to the present embodiment will be described with reference to FIG. 4.

The terminal device 20 includes a communication unit 21, a storage unit 22, an input unit 23, an output unit 24, a control unit 25, and a camera 26.

The communication unit 21 includes a communication module connected to the network 50. For example, the communication unit 21 may include a communication module compatible with mobile communication standards such as Long-Term Evolution (LTE), 4th generation (4G), and 5th generation (5G). In the present embodiment, the terminal device 20 is connected to the network 50 via the communication unit 21. The communication unit 21 sends and receives various kinds of information via the network 50. The communication unit 21 can communicate with the information processing device 10 and the vehicle 30 via the network 50.

For example, the storage unit 22 is, but not limited to, a semiconductor memory, a magnetic memory, or an optical memory. The storage unit 22 may function as, for example, a main storage device, an auxiliary storage device, or a cache memory. The storage unit 22 stores any information to be used for the operation of the terminal device 20. For example, the storage unit 22 may store a system program, an application program, and various kinds of information received by the communication unit 21. The information stored in the storage unit 22 may be updatable with, for example, information received from the network 50 via the communication unit 21. A part of the storage unit 22 may be installed outside the terminal device 20. In that case, the part of the storage unit 22 installed outside the terminal device 20 may be connected to the terminal device 20 via a desired interface.

The input unit 23 includes one or more input interfaces that detect user input and acquire input information based on the user's operation. For example, the input unit 23 includes, but not limited to, a physical key, a capacitive key, a touch screen integrated with a display of the output unit 24, or a microphone that accepts voice input.

The output unit 24 includes one or more output interfaces that output information to notify the user. For example, the output unit 24 includes, but not limited to, a display that outputs information as images or a speaker that outputs information as audio.

The control unit 25 includes one or more processors, one or more dedicated circuits, or a combination thereof. The processor is a general-purpose processor such as CPU or GPU, or a dedicated processor specialized for a specific process. The dedicated circuit is, for example, an FPGA or an ASIC. The control unit 25 performs processes related to the operation of the terminal device 20 while controlling each unit of the terminal device 20.

The camera 26 is a camera capable of capturing images.

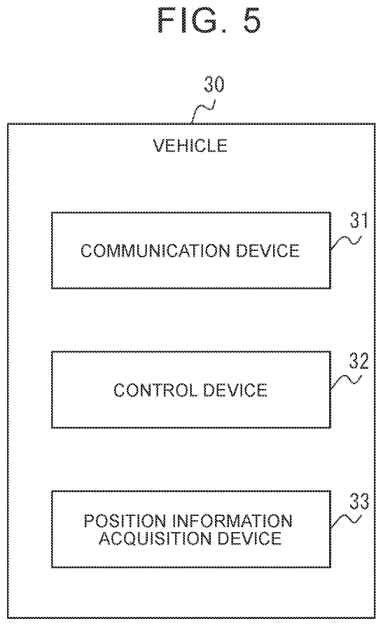

The configuration of the vehicle 30 according to the present embodiment will be described with reference to FIG. 5.

The vehicle 30 includes a communication device 31, a control device 32, and a position information acquisition device 33. The communication device 31, the control device 32, and the position information acquisition device 33 are connected to each other via an in-vehicle network such as Controller Area Network (CAN) or a dedicated line so that they can communicate with each other.

The communication device 31 includes a communication module connected to the network 50. For example, the communication device 31 may include a communication module compatible with mobile communication standards such as LTE, 4G, and 5G. In the present embodiment, the vehicle 30 is connected to the network 50 via the communication device 31. The communication device 31 sends and receives various kinds of information via the network 50. The communication device 31 can communicate with the information processing device 10 and the terminal device 20 via the network 50.

The control device 32 includes at least one processor, at least one dedicated circuit, or a combination thereof. The processor is a general-purpose processor such as CPU or GPU, or a dedicated processor specialized for a specific process. The dedicated circuit is, for example, an FPGA or an ASIC. The control device 32 performs processes related to the operation of the vehicle 30 while controlling each unit of the vehicle 30.

The position information acquisition device 33 includes one or more receivers compatible with a desired satellite positioning system. For example, the position information acquisition device 33 may include a Global Positioning System (GPS) receiver. The position information acquisition device 33 acquires a measured value of the position of the vehicle 30 as position information. The position information includes, for example, an address, latitude, longitude, and altitude.

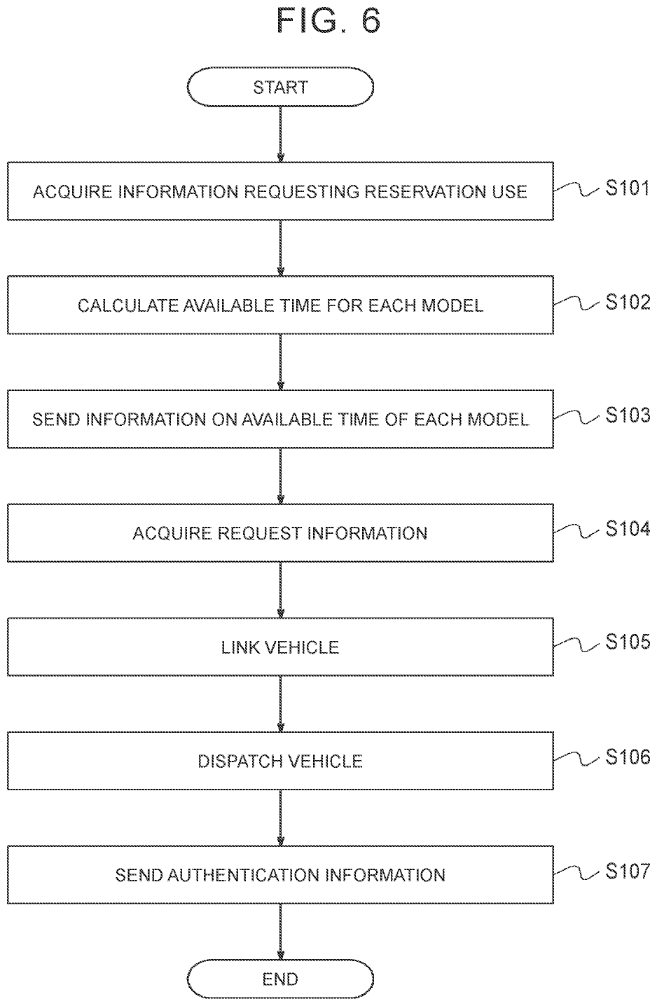

The information processing device 10 configured as described above manages the vehicles 30 by acquiring information identifying the model and vehicle body of the vehicle 30 and position information of the vehicle 30 from the vehicle 30 at a desired timing and dynamically assigning each vehicle 30 to reservation use or on-demand use. For example, the control unit 15 of the information processing device 10 manages information such as the distribution status of the vehicles 30 in the backyard 201 and each on-demand waiting area 203, the model of each vehicle 30 in the backyard 201 and each on-demand waiting area 203, and the reservation status for each model by storing this information in the storage unit 12 and updating this information as necessary. The operation for such management will be described in detail with reference to FIGS. 6 to 15.

FIG. 6 is a flowchart showing an example of an operation procedure of the information processing device 10 when managing reservation use. The procedure of FIG. 6 is performed when the input unit 23 of the terminal device 20 accepts an input requesting reservation use from the user who desires reservation use and the control unit 25 of the terminal device 20 sends information requesting reservation use to the information processing device 10 via the communication unit 21.

The control unit 15 of the information processing device 10 acquires via the communication unit 11 the information requesting reservation use sent from the terminal device 20 (step S101).

The control unit 15 calculates an available time for each model of the vehicles 30 (step S102). The available time is the maximum time for which the vehicle 30 of each model is available for reservation use. The control unit 15 calculates the available time by subtracting a lead time and a downtime from the time available until the next reservation of the vehicle 30. The lead time is the amount of time set as an estimated time required to dispatch the reserved vehicle 30 to the pickup location desired by the user. The lead time is, for example, 30 minutes. The downtime is the amount of time set as a service unavailable time until the vehicle 30 becomes available to the next user after one user uses the vehicle 30. Specifically, the downtime is the amount of time set as desired in view of the time required to charge the vehicle 30, the time required to clean the vehicle 30, the time required to inspect the vehicle 30, etc. The downtime may be different for each model. The control unit 15 calculates the available pickup date and time when the vehicle 30 becomes available for reservation use as the lead time from the current time. When the available time is longer than an upper limit (e.g., one week or two weeks) set as desired, the control unit 15 may set the available time to the value of the upper limit of the available time. The control unit 15 calculates the available time for each model. When there is more than one available vehicle 30 of the same model, the control unit 15 calculates the available time of each of those available vehicles 30 and selects the longest one of the calculated available times as the available time of that model.

The control unit 15 sends information on the available time of each model to the terminal device 20 via the communication unit 11 (step S103).

When the control unit 25 of the terminal device 20 acquires the information on the available time of each model, the control unit 25 causes the output unit 24 to display the information on the available time of each model.

After checking the information on the available time of each model, the user enters request information for reservation use of the vehicle 30 to the input unit 23 of the terminal device 20. The user enters, for example, information on the model, pickup date and time, scheduled return date and time, and pickup location. The control unit 25 sends the request information entered by the user to the information processing device 10 via the communication unit 21.

The control unit 15 of the information processing device 10 acquires via the communication unit 11 the request information sent from the terminal device 20 (step S104).

The control unit 15 links the vehicle 30 to the acquired request information (step S105). As used herein, linking the vehicle 30 means identifying the vehicle 30 to be used for reservation use based on the acquired required information. Linking of the vehicle 30 will be described in detail later.

The control unit 15 dispatches the vehicle 30 so that the vehicle 30 arrives at the desired pickup location at least a predetermined time before the pickup date and time (step S106). The predetermined time is, for example, 10 minutes. For example, when the pickup date and time is 10:00 on January 1st and the predetermined time is 10 minutes, the control unit 15 dispatches the vehicle 30 so that the vehicle 30 arrives at the desired pickup location by 9:50 on January 1st. When the vehicle 30 receives a dispatch command from the control unit 15, the vehicle 30 autonomously heads for the pickup location desired by the user.

The control unit 15 sends authentication information for the user to pick up the dispatched vehicle 30 to the terminal device 20 via the communication unit 11 (step S107).

The user can start using the vehicle 30 by going to the desired pickup location on the pickup date and time and performing an authentication process for the vehicle 30 parked at the pickup location using the authentication information acquired by the terminal device 20.

The user who has finished using the vehicle 30 drops off the vehicle 30 at a desired location. For example, the user may drop off the vehicle 30 either in the pickup and drop-off area 202 of the parking area 2 or at other location. After the user drops off the vehicle 30, the vehicle 30 autonomously returns to the backyard 201 of the parking area 2.

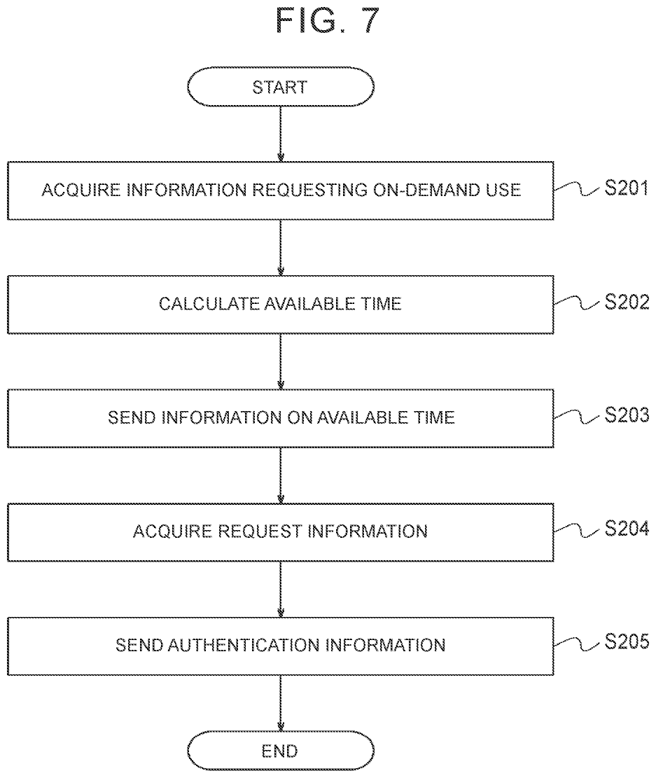

FIG. 7 is a flowchart showing an example of an operation procedure of the information processing device 10 when managing on-demand use. The procedure of FIG. 7 is performed when the user who desires on-demand use goes to the on-demand waiting area 203 in any parking area 2 and takes a picture of the two-dimensional code attached to the vehicle 30 waiting in the on-demand waiting area 203 by the camera 26 of the terminal device 20 and the control unit 25 sends information included in the two-dimensional code to the information processing device 10 via the communication unit 21.

The control unit 15 of the information processing device 10 acquires via the communication unit 11 information requesting on-demand use sent from the terminal device 20 (step S201).

The control unit 15 calculates the available time of the vehicle 30 (step S202). The vehicle 30 whose available time is calculated by the control unit 15 is the vehicle 30 a picture of whose two-dimensional code has been taken by the terminal device 20. The control unit 15 calculates the available time by subtracting the downtime from the time available until the next reservation of the vehicle 30. The control unit 15 calculates the available pickup date and time when the vehicle 30 becomes available for on-demand use as the current time. When the control unit 15 calculates the available time for on-demand use and the calculated available time is longer than an upper limit (e.g., 12 hours) set as desired, the control unit 15 may set the available time to the value of the upper limit of the available time.

The control unit 15 sends information on the calculated available time to the terminal device 20 via the communication unit 11 (step S203).

When the control unit 25 of the terminal device 20 acquires the information on the available time of the vehicle 30 parked in the on-demand waiting area 203, the control unit 25 causes the output unit 24 to display the information on the available time.

After checking the information on the available time of the vehicle 30 parked in the on-demand waiting area 203, the user enters request information for on-demand use of the vehicle 30 to the input unit 23 of the terminal device 20. When the user enters the request information, the user enters information on scheduled return date and time. The control unit 25 sends the request information entered by the user to the information processing device 10 via the communication unit 21.

The control unit 15 of the information processing device 10 acquires via the communication unit 11 the request information sent from the terminal device 20 (step S204).

The control unit 15 sends authentication information for the user to pick up the vehicle 30 parked in the on-demand waiting area 203 to the terminal device 20 via the communication unit 11 (step S205).

The user starts using the vehicle 30 by performing an authentication process for the vehicle 30 parked in the on-demand waiting area 203 using the authentication information acquired by the terminal device 20.

The user who has finished using the vehicle 30 drops off the vehicle 30 at a desired location. For example, the user may drop off the vehicle 30 either in the pickup and drop-off area 202 of the parking area 2 or at other location. After the user drops off the vehicle 30, the vehicle 30 autonomously returns to the backyard 201 of the parking area 2.

The information processing device 10 manages reservation use and on-demand use according to the procedures shown in FIGS. 6 and 7. The number of vehicles 30 that should wait in the on-demand waiting area 203 is set in advance to any value in order to maximize the opportunity profit. However, when one or more vehicles 30 are provided for on-demand use, the on-demand waiting area 203 will become short of an available vehicle(s) 30. Accordingly, in order to minimize the opportunity cost due to the shortage of the vehicle(s) 30, the information processing device 10 replenishes with the vehicle 30 that is provided for on-demand use.

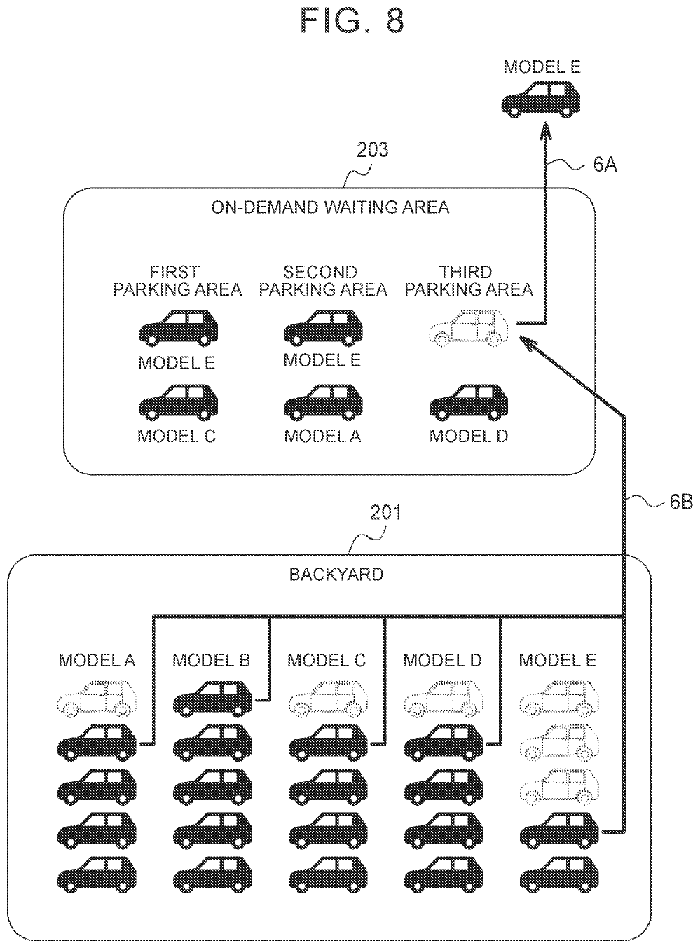

FIG. 8 schematically illustrates the operation of replenishing with the vehicle 30 that is provided for on-demand use by the information processing device 10. FIG. 8 shows the parking areas 2 of FIG. 2 as an example. Specifically, FIG. 8 shows the wait status of the vehicles 30 in the on-demand waiting area 203 in each of the first to third parking areas 2 and the storage status of the vehicles 30 in the backyard 201. For example, in the first to third parking areas 2, a total of 25 vehicles 30, five for each model A, B, C, D, and E, are distributed to the on-demand waiting areas 203 and the backyard 201. For example, the first to third parking areas 2 are configured so that a total of six vehicles 30 wait in the on-demand waiting areas 203 of the first to third parking area 2, two in each on-demand waiting area 203. FIG. 8 shows a situation in which one vehicle 30 of model E is in on-demand use (arrow 6A). Specifically, one vehicle 30 of model C and one vehicle 30 of model E were waiting in the on-demand waiting area 203 of the first parking area 2, one vehicle 30 of model A and one vehicle 30 of model E were waiting in the on-demand waiting area 203 of the second parking area 2, and one vehicle 30 of model D and one vehicle 30 of model E were waiting in the on-demand waiting area 203 of the third parking area 2, and therefore the on-demand waiting area 203 of the third parking area 2 is short of one vehicle 30. A total of 19 vehicles 30, four of model A, five of model B, four of model C, four of model D, and two of model E, are stored in the backyard 201. In order to replenish the on-demand waiting area 203 of the third parking area 2 with the vehicle 30 of model E, the information processing device 10 assigns one vehicle 30 of model E stored in the backyard 201 to on-demand use as appropriate, and sends a command to that vehicle 30 to move to the on-demand waiting area 203 of the third parking area 2 (arrow 6B).

In each parking area 2, such replenishment is made by moving the vehicle 30 from the backyard 201 of that parking area 2 to the on-demand waiting area 203 of that parking area 2. The replenishment may be made with the vehicle 30 from the backyard 201 of a different parking area 2. In the present embodiment, since the first to third parking areas 2 share the backyard 201, the replenishment in each parking area 2 is made by moving the vehicle 30 from the common backyard 201 to the on-demand waiting area 203 of each parking area 2.

Since the vehicles 30 stored in the backyard 201 are provided for reservation use, it is desirable to make such replenishment for on-demand use while not hindering dispatching of the vehicles 30 for reservation use. Accordingly, the information processing device 10 determines the model and the vehicle 30 to be moved to the on-demand waiting area 203 for replenishment according to the reservation status of the models stored in the backyard 201. This operation procedure will be described below.

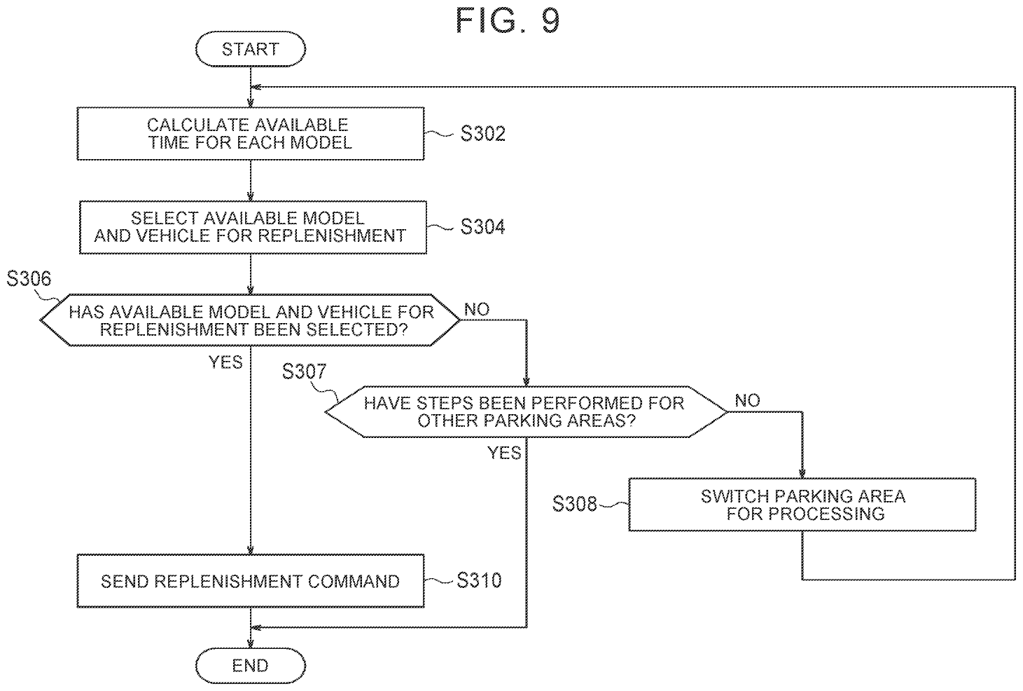

FIG. 9 is a flowchart showing an example of an operation procedure that is performed when the information processing device 10 replenishes with the vehicle 30 that is provided for on-demand use. The procedure of FIG. 9 is performed when the vehicle 30 is in on-demand use by the user and the on-demand waiting area 203 becomes short of the vehicle 30, that is, after step S205 of FIG. 7. For example, the control unit 15 performs the procedure of FIG. 9 once it confirms from the position information received from the vehicle 30 that the vehicle 30 has moved from the on-demand waiting area 203 for on-demand use based on the authentication information sent in step S205. The procedure of FIG. 9 is performed every time the on-demand waiting area 203 becomes short of one vehicle 30. Specifically, the procedure of FIG. 9 is performed on the vehicle 30 stored in the backyard 201 of the parking area 2 to which this on-demand waiting area 203 belongs.

The control unit 15 calculates the available time for each model of the vehicles 30 stored in the backyard 201 based on the reservation status (step S302). The available time is the amount of time for which the model stored for reservation use is available when assigned to on-demand use, and is the longest of the available times of the vehicles 30 of each model. The control unit 15 calculates the available time by subtracting a lead time and a downtime from the time available until the next reservation of the vehicle 30. The lead time is the amount of time set as an estimated time required for the vehicle 30 to move from the backyard 201 to the on-demand waiting area 203. The lead time varies according to the distance between the backyard 201 and the on-demand waiting area 203 and is, for example, a few minutes to 30 minutes. The downtime is the amount of time set as a service unavailable time until the vehicle 30 becomes available to the next user after one user uses the vehicle 30. Specifically, the downtime is the amount of time set as desired in view of the time required to charge the vehicle 30, the time required to clean the vehicle 30, the time required to inspect the vehicle 30, etc. The downtime may be different for each model. The control unit 15 calculates the available pickup date and time when the vehicle 30 becomes available for on-demand use as the lead time from the current time. When the available time is longer than an upper limit (e.g., 12 hours) set as desired, the control unit 15 may set the available time to the value of the upper limit of the available time. The control unit 15 calculates the available time for each model. When there is more than one available vehicle 30 of the same model, the control unit 15 calculates the available time of each of the available vehicles 30 and selects the longest one of the calculated available times as the available time of that model.

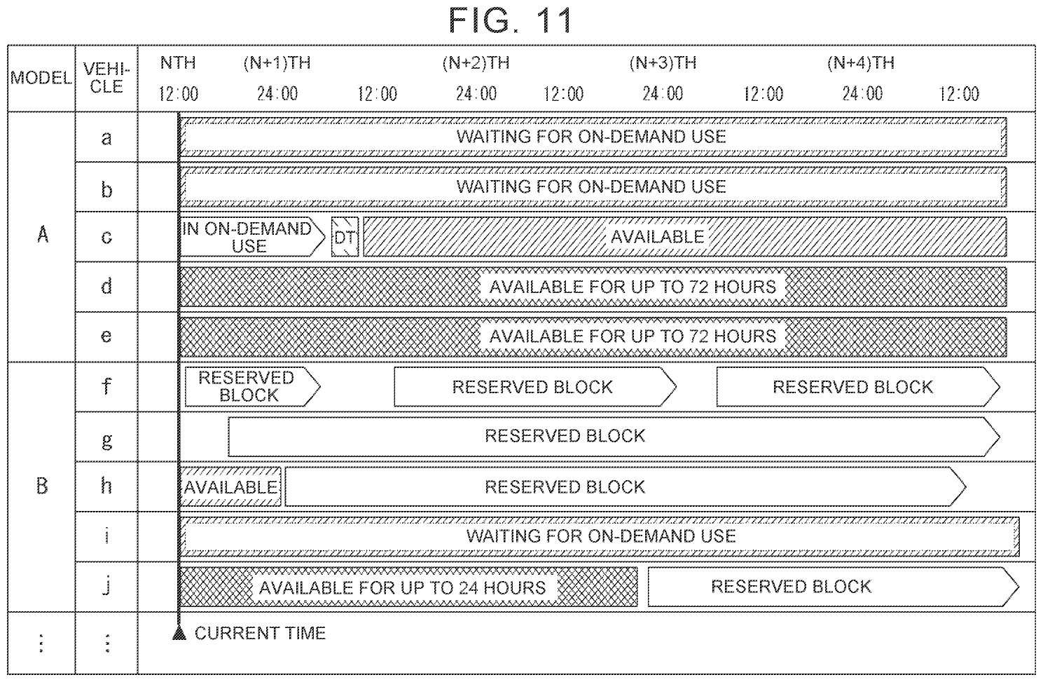

FIG. 11 shows an example of a reservation table for the control unit 15 to manage the vehicles 30. This reservation table shows the reservation status of five vehicles 30 of each model A, B, namely, the reservation status of vehicles a, b, c, d, and e of model A and vehicles f, g, h, i, and j of model B. In this reservation table, the abscissa represents time. For example, the vehicles a, b, and c of model A and the vehicle i of model B are currently provided for on-demand use. The vehicles a, b, and i are waiting for on-demand use, and the vehicle c is in on-demand use. The vehicle c is scheduled to be used until the next day and will then become available after the downtime DT. The vehicles d and e of model A are currently available and can be used up to 72 hours from the current time. The vehicle f of model B has been reserved intermittently and continually, and this status is shown by reserved blocks. The vehicles g and h of model B have been reserved from afternoon and midnight of the same day, respectively. The vehicle j of model B is available for 24 hours from the current time and has been reserved after that. In this situation, the control unit 15 selects the available time of the vehicle d or e, namely 72 hours, as the available time of model A, and the available time of the vehicle j, namely 24 hours, as the available time of model B.

Returning back to FIG. 9, the control unit 15 then selects the available model and the vehicle 30 of the available model for replenishment (step S304).

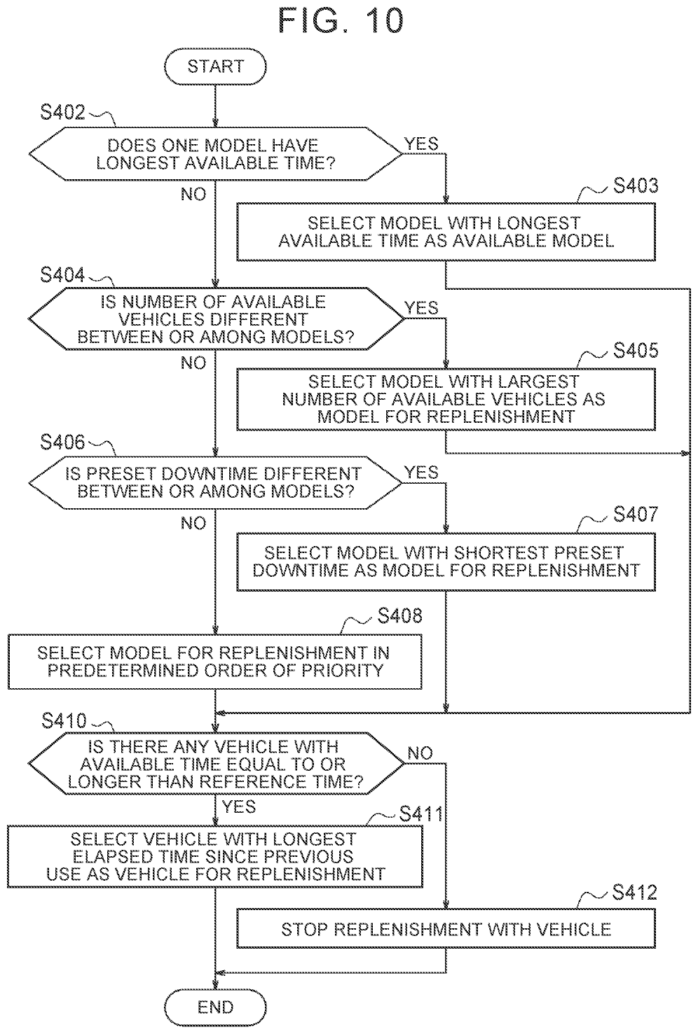

FIG. 10 is a flowchart showing a detailed procedure of step S304 of FIG. 9. When one model has the longest available time (Yes in step S402), the control unit 15 selects that model as the available model (step S403). In the example of FIG. 11, since the available time of model A is 72 hours and the available time of model B is 24 hours, the control unit 15 selects model A as the available model. Referring back to FIG. 10, the control unit 15 then proceeds to step S410.

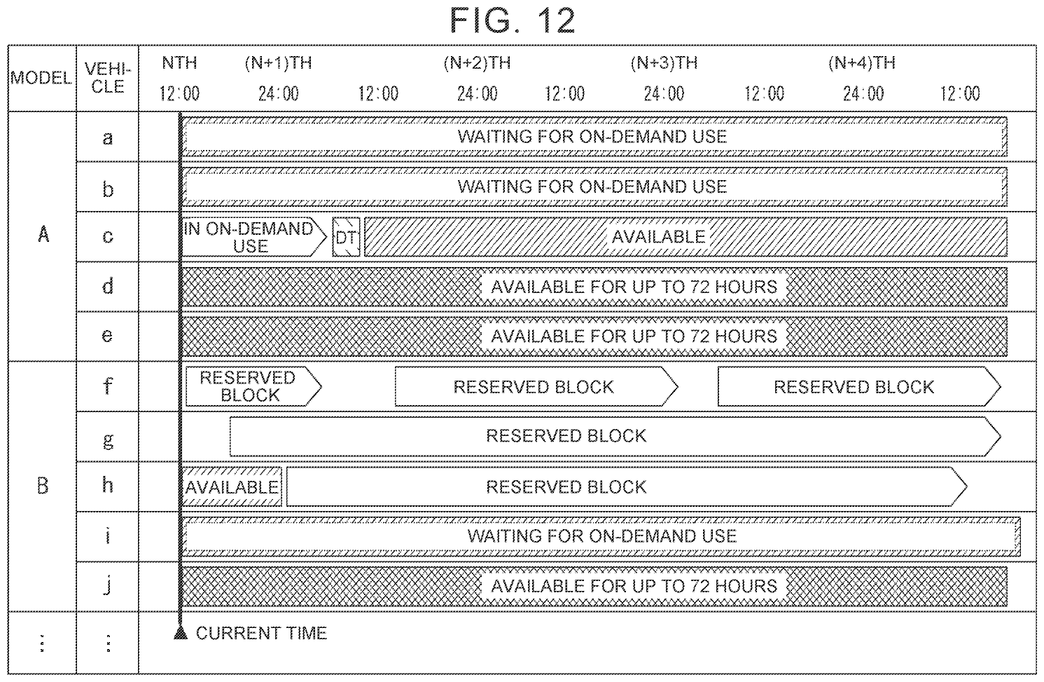

When more than one model has the longest available time (No in step S402), the control unit 15 determines whether the number of available vehicles 30 is different between or among the models having the longest available time (step S404). When the number of available vehicles 30 is different between or among the models having the longest available time (Yes in step S404), the control unit 15 selects the model with the largest number of available vehicles 30 as the available model (step S405). This reduces the risk that immediately after replenishment with the vehicle 30 was made for on-demand use, a reservation is made for the model of that vehicle 30 and the reservation cannot be accepted. For example, a reservation table shown in FIG. 12 is different from the reservation table shown in FIG. 11 in that the available time of the vehicle j of model B is 72 hours. In the reservation table of FIG. 12, the available time is 72 hours for both models A and B. Two vehicles d, e of model A and one vehicle j of model B are available. Since the number of available vehicles of model A is larger than the number of available vehicles of model B, the control unit 15 selects model A as the available model. The control unit 15 then proceeds to step S410 in FIG. 10.

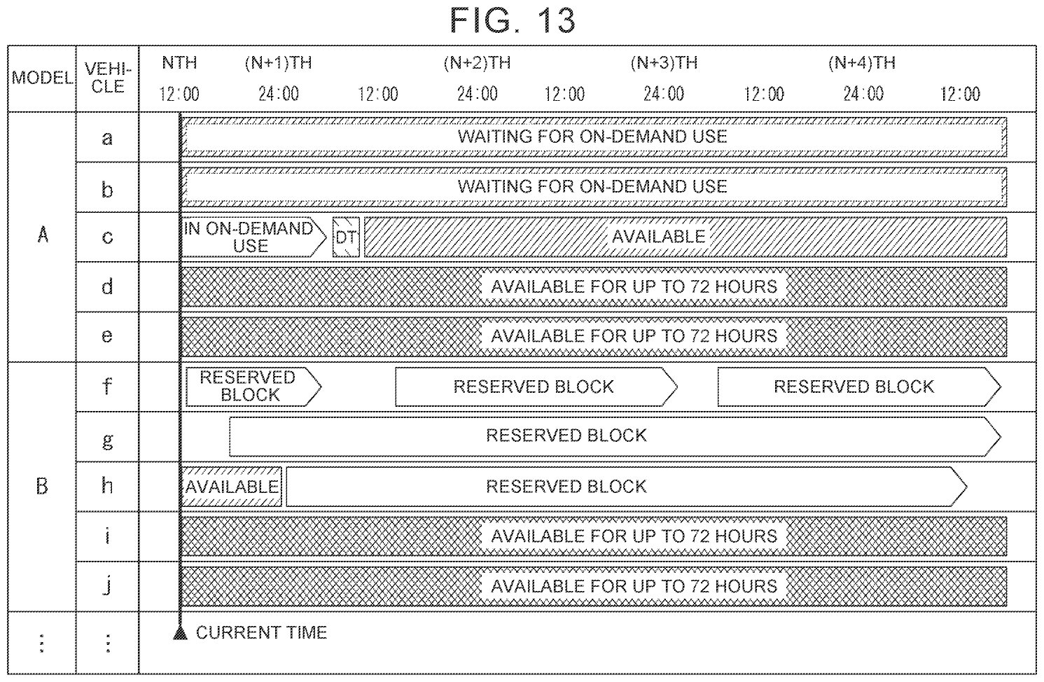

When the numbers of available vehicles 30 of a plurality of models are the same (No in step S404), the control unit 15 determines whether the preset downtime is different between or among the models (step S406). When the preset downtime is different between or among the models (Yes in step S406), the control unit 15 selects the model with the shortest preset downtime as the available model (step S407). It is probable that the replenished model has a high utilization rate. The utilization rate of that model can be maximized by replenishing with the model having a short preset downtime. For example, a reservation table shown in FIG. 13 is different from the reservation table shown in FIG. 12 in that the available time of the vehicle i of model B is 72 hours. In the reservation table of FIG. 13, the available time is 72 hours for both models A and B, and two vehicles d, e of model A and two vehicle i, j of model B are available. Assuming that the preset downtime of model A is 3 hours and the preset downtime of model B is 1 hour, the control unit 15 selects model B with a shorter preset downtime as the available model. The control unit 15 then proceeds to step S410 in FIG. 10.

When the preset downtime is the same between or among the models (No in step S406), the control unit 15 selects the available model in order of priority set as desired in advance (step S408). The control unit 15 then proceeds to step S410 in FIG. 10.

When there is any vehicle 30 of the selected model that has an available time equal to or longer than a reference time (Yes in step S410), the control unit 15 selects the vehicle 30 with the longest elapsed time since the previous use as the vehicle 30 for replenishment from the vehicles 30 with an available time equal to or longer than the reference time (step S411). The control unit 15 thus ends the procedure of FIG. 10. The reference time is the amount of time during which the use of the vehicle 30 is expected to occur with a certain degree of probability. The reference time is about 1 to 3 hours and is set as desired. For example, the reference time is 2 hours.

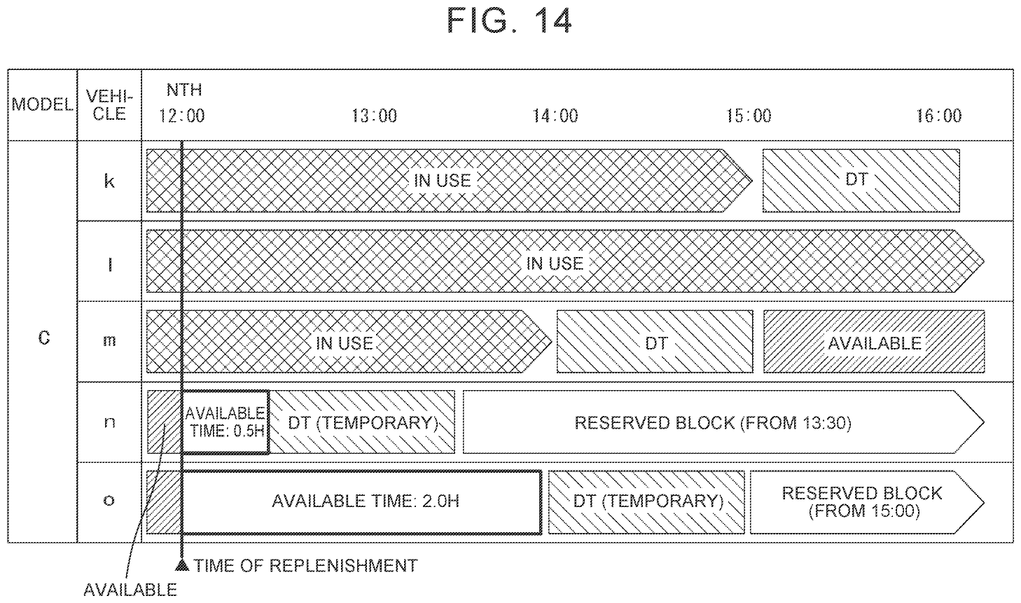

FIG. 14 shows an example of a reservation table for model C. This reservation table shows the reservation status of five vehicles 30 of model C, that is, the reservation status of vehicles k, l, m, n, and o. In this reservation table, the abscissa represents time. Of the vehicles 30, the available times of the vehicles n, o are 0.5 hours and 2.0 hours, respectively. For example, when model C is selected as the available model, the control unit 15 selects the vehicle o with an available time equal to or longer than the reference time, namely equal to or longer than 2 hours, as the vehicle 30 for replenishment. If there is any vehicle 30 of model C other than the vehicle o that has an available time equal to or longer than 2 hours, the control unit 15 selects the vehicle 30 with the longest elapsed time since the previous use as the vehicle 30 for replenishment. This equalizes the utilization rates among the vehicles 30 and wear due to operation load among the vehicles 30.

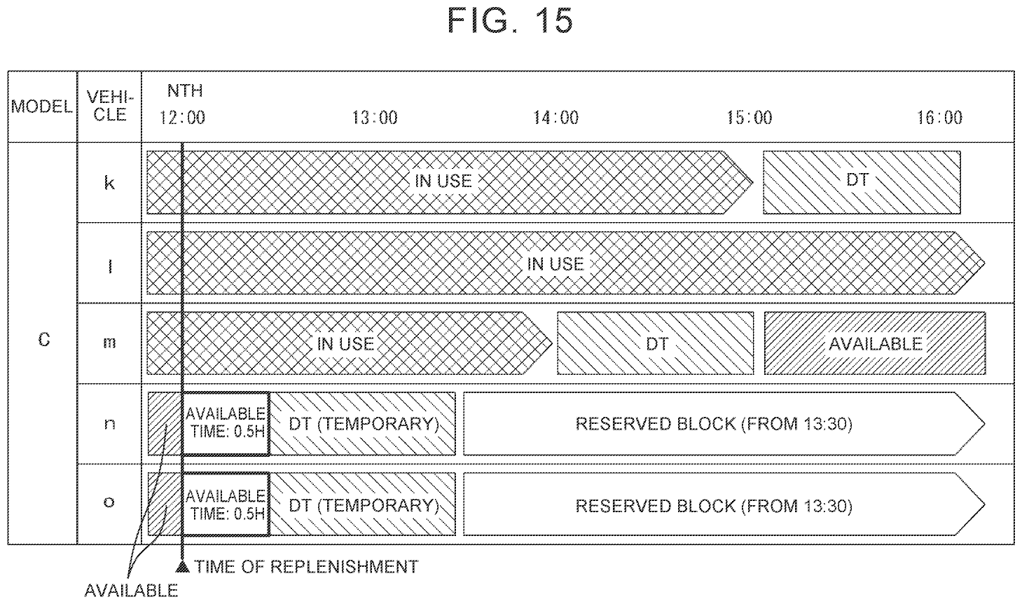

Referring back to FIG. 10, when no vehicle 30 has an available time equal to or longer than the reference time (No in step S410), the control unit 15 stops replenishment with the vehicle 30 for on-demand use (step S412), and ends the procedure of FIG. 10. For example, a reservation table shown in FIG. 15 is different from the reservation table shown in FIG. 14 in that the available time of the vehicle o is 0.5 hours. In the reservation table of FIG. 15, no vehicle 30 has an available time equal to or longer than 2 hours. Accordingly, the control unit 15 stops replenishment with the vehicle 30 for on-demand use.

When the vehicle 30 waits for on-demand use, the vehicle 30 needs to wait for a period of time during which the vehicle 30 is expected to be used with a certain degree of probability. This is because replenishment may otherwise become a waste. Since replenishment is stopped when there is no vehicle 30 having an available time equal to or longer than the reference time, the risk of such a waste is reduced. When the replenishment is stopped, replenishment is not made with the vehicle 30 from the parking area 2 for the procedure of FIG. 10.

Referring back to FIG. 9, when the available model and the vehicle 30 for replenishment are selected as a result of step S304 (Yes in step S306), the control unit 15 sends a replenishment command to the selected vehicle 30 for replenishment (step S310). The replenishment command is a command to move the vehicle 30 for replenishment to the on-demand waiting area 203 that is short of the vehicle 30. The replenishment command includes information identifying the vehicle 30 for replenishment, information identifying the on-demand waiting area 203, information on the point where the vehicle 30 for replenishment is supposed to wait in the on-demand waiting area 203, etc. The vehicle 30 having received the replenishment command moves to the on-demand waiting area 203 in response to the replenishment command.

When the available model and the vehicle 30 for replenishment are not selected (No in step S306), the control unit 15 determines whether steps S302 and S304 have been performed for the other parking areas (step S307). When steps S302 and S304 have not been performed for the other parking areas (No in step S307), the control unit 15 switches the parking area 2 for which steps S302 and S304 are to be performed to one of these parking areas 2 (step S308), and steps S302 and S304 are performed for this parking area 2. When the available model and the vehicle 30 for replenishment are selected for another parking area 2 as a result of step S304 (Yes in step S306), the control unit 15 sends a replenishment command to the selected vehicle 30 for replenishment (step S310). The on-demand waiting area 203 is thus replenished with the vehicle 30, and the risk of the opportunity cost is minimized. When the available model and the vehicle 30 for replenishment are not selected for any of the parking areas 2 (Yes in step S307), the control unit 15 ends the procedure of FIG. 9. In that case, the on-demand waiting areas 203 are not replenished with the vehicle 30.

Even when the on-demand waiting areas 203 are not replenished with the vehicle 30, the control unit 15 of the information processing device 10 performs the procedure of FIG. 9 at desired intervals (e.g., at intervals of several minutes to several tens of minutes) or every time the vehicle 30 returns to the backyard 201. The on-demand waiting area 203 can thus be replenished with the vehicle 30 as soon as there is a vehicle 30 in the backyard 201 that satisfies a condition for replenishment.

As described above, in the information processing device 10 of the present embodiment, the control unit 15 acquires the request information for the use of the vehicle 30 from the user either as request information for reservation use or request information for on-demand use. Even when the on-demand waiting area 203 becomes short of a certain model or short of the vehicle 30, the information processing device 10 can replenish the on-demand waiting area 203 with the model or the vehicle 30 from the backyard 201 while not hindering reservation use. It is therefore possible to improve the efficiency of management of the vehicles 30 for on-demand use.

How to replenish the on-demand waiting area 203 with the vehicle 30 from the backyard 201 when the on-demand waiting area 203 is short of the vehicle 30 because the vehicle 30 in the on-demand waiting area 203 is in on-demand use is described in the above example. Hereinafter, another example in which an opportunity to replenish the on-demand waiting area 203 with the vehicle 30 from the backyard 201 occurs will be described.

In one embodiment, when the available time of the vehicle 30 waiting in the waiting location for on-demand use, that is, the on-demand waiting area 203, becomes shorter than the reference time, that is, when the available time of the vehicle 30 stored in the backyard 201, namely the storage location, is equal to or longer than the reference time, the control unit 15 of the information processing device 10 sends a command to the vehicle 30 in the on-demand waiting area 203 to move to the backyard 201 and sends a command to the vehicle 30 in the backyard 201 to move to the on-demand waiting area 203. The reference time is the reference time used to select the vehicle 30 for replenishment in step S410 of FIG. 10 and is the minimum time that guarantees provision of on-demand use. The reference time is, for example, 2 hours, 1.5 hours, etc. As described above, not only when the on-demand waiting area 203 becomes short of the vehicle 30 due to on-demand use, but also when the available time of the vehicle 30 in the on-demand waiting area 203 becomes short as time passes, the on-demand waiting area 203 is replenished with the vehicle 30 from the backyard 201 and the vehicle 30 whose available time has become short is assigned to reservation use and moved to the backyard 201. That is, the information processing device 10 switches the vehicles 30 between the on-demand waiting area 203 and the backyard 201.

Even when the available time of the vehicle 30 in the on-demand waiting area 203 is equal to or longer than the reference time, the control unit 15 of the information processing device 10 switches the vehicles 30 between the on-demand waiting area 203 and the backyard 201 when the available time of the vehicle 30 in the backyard 201 has been changed and thus has become longer than the available time of the vehicle 30 in the on-demand waiting area 203. There is a case where a reservation for reservation use of the vehicle 30 stored in the backyard 201 is cancelled or the vehicle 30 being in reservation use is returned earlier than scheduled. In this case, the vehicle 30 will have an unexpected additional available time. Accordingly, there may be the vehicle 30 in the backyard 201 whose available time is longer than the available time of the vehicle 30 in the on-demand waiting area 203. In this case as well, the information processing device 10 switches the vehicles 30 between the on-demand waiting area 203 and the backyard 201.

By switching the vehicles 30 between the on-demand waiting area 203 and the backyard 201 in this manner, the available times of the vehicles 30 in the on-demand waiting area 203 can always be kept equal to or longer than a certain amount of time, and the opportunity profit from on-demand use can be maximized.

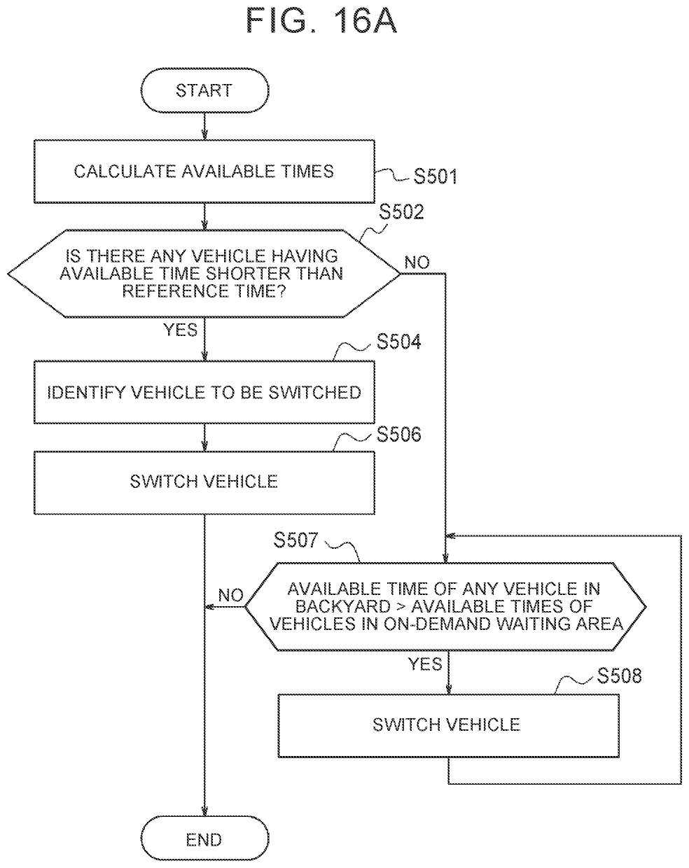

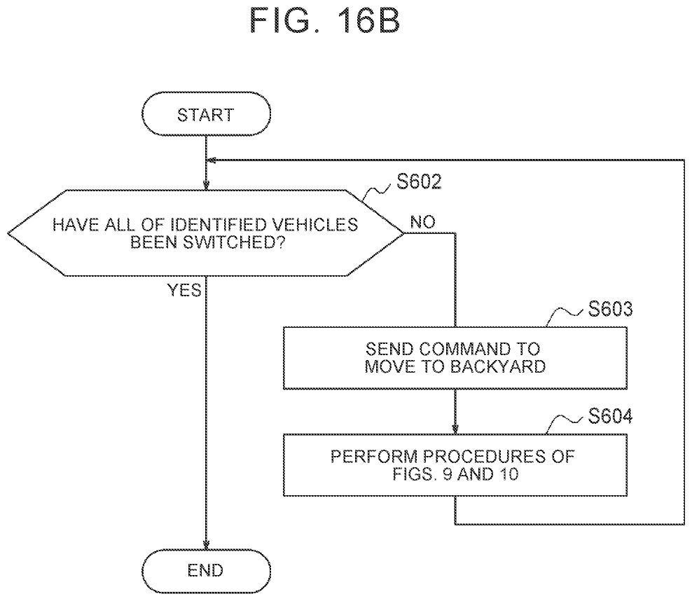

FIGS. 16A and 16B are flowcharts illustrating an example of an operation procedure of the information processing device 10 in the embodiment.

The procedure of FIG. 16A is performed at desired intervals (e.g., at intervals of several minutes to several tens of minutes).

The control unit 15 calculates the available times of the vehicles 30 in the on-demand waiting area 203 (step S501). As a result of the information processing device 10 managing reservation use according to the procedure shown in FIG. 6, a future reservation for reservation use may be made to the vehicle 30 assigned to on-demand use and waiting in the on-demand waiting area 203. The control unit 15 identifies the vehicle 30 for on-demand use waiting in the on-demand waiting area 203 from the reservation table and the position information of each vehicle 30, and calculates the current available time of that vehicle 30 by subtracting the downtime from the time available until the next reservation of that vehicle 30.

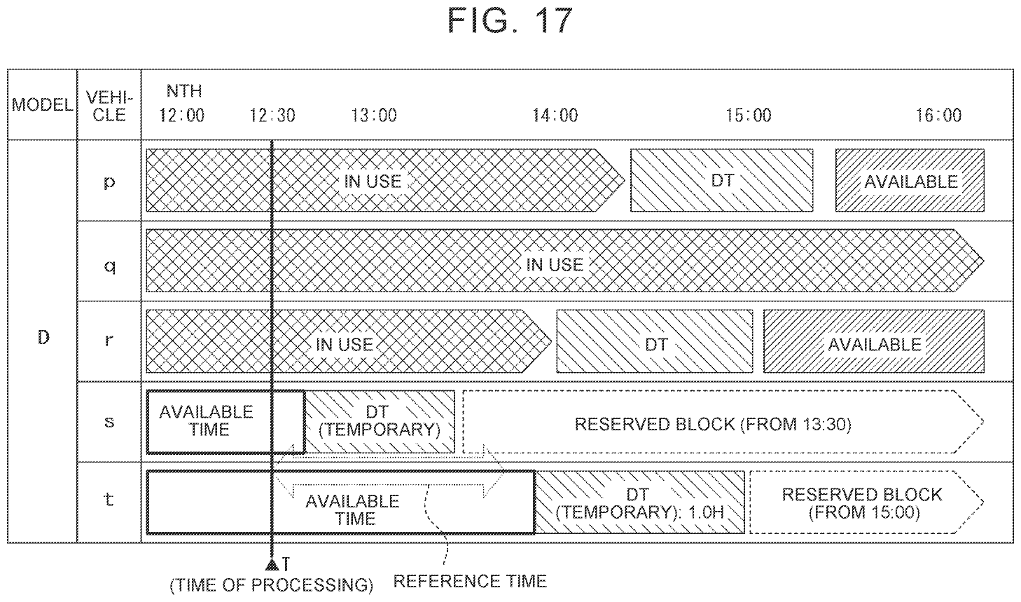

When any of the vehicles 30 in the on-demand waiting area 203 has an available time shorter than the reference time (Yes in step S502), the control unit 15 identifies that vehicle 30 as a vehicle to be switched (step S504). For example, in a reservation table for vehicles p, q, r, s, and t of model D shown in FIG. 17, the vehicles p, q, and r are in use and the vehicles s and t have an available time at the time of processing T. Since the available time of the vehicle s after the time of processing T is shorter than the reference time and the available time of the vehicle t after the time of processing T is equal to or longer than the reference time, the control unit 15 identifies the vehicle s as a vehicle to be switched.

The control unit 15 performs the vehicle switching process for each vehicle 30 identified as a vehicle to be switched (step S506), and ends the procedure of FIG. 16A.

The procedure of FIG. 16B illustrates step S506 of FIG. 16A in detail.

The control unit 15 performs steps S603 and S604 for each vehicle 30 until the vehicle switching process is finished for all the vehicles 30 identified as vehicles to be switched (No in step S602). The control unit 15 assigns the vehicle 30 identified as a vehicle to be switched to reservation use, and sends a command to that vehicle 30 to move to the backyard 201 (step S603). The control unit 15 then performs the procedure of FIG. 9 including the procedure of FIG. 10 in order to replenish the vehicle 30 assigned for reservation use. At that time, in step S410 of FIG. 10, the control unit 15 selects the vehicle 30 whose available time is equal to or longer than the reference time. When the vehicle switching process is finished for all the vehicles 30 identified as vehicles to be switched (Yes in step S602), the control unit 15 ends the procedure of FIG. 16B.

Referring back to step S502 of FIG. 16A, when there is no vehicle 30 in the on-demand waiting area 203 whose available time is shorter than the reference time (No in step S502), the control unit 15 determines whether any of the vehicles 30 stored in the backyard 201 has an available time longer than the available times of the vehicles 30 waiting in the on-demand waiting area 203 (step S507). The control unit 15 calculates the available time of each of the vehicles 30 stored in the backyard 201 by subtracting the lead time and the downtime from the time available until the next reservation of that vehicle 30. The control unit 15 then compares the available time of each vehicle 30 in the backyard 201 with the available time of each vehicle 30 in the on-demand waiting area 203.

When there is any vehicle 30 stored in the backyard 201 whose available time is longer than the available times of the vehicles 30 waiting in the on-demand waiting area 203 (Yes in step S507), namely, for example, when a reservation for reservation use of the vehicle 30 stored in the backyard 201 has been cancelled or the vehicle 30 in reservation use was returned earlier than scheduled, the control unit 15 switches that vehicle 30 in the backyard 201 with the vehicle 30 in the on-demand waiting area 203 whose available time is shorter than the available time of that vehicle 30 (step S508). For example, the control unit 15 assigns the vehicle 30 having the shortest available time in the on-demand waiting area 203 to reservation use and sends a command to that vehicle 30 to move to the backyard 201. The control unit 15 also assigns the vehicle 30 having the longest available time in the backyard 201 to on-demand use and sends a command to that vehicle 30 to move to the on-demand waiting area 203.

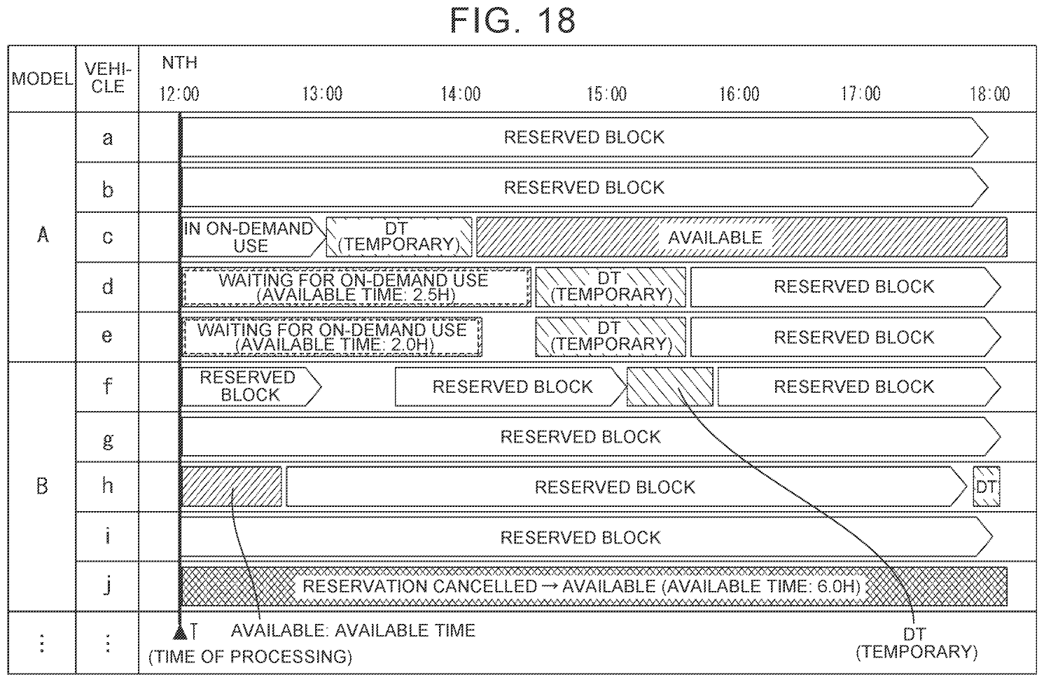

For example, a reservation table shown in FIG. 18 shows the reservation status of vehicles a, b, c, d, and e of model A and vehicles f, g, h, i, and j of model B. In this reservation table, the vehicles c, d, and e of model A are assigned to on-demand use, and the other vehicles are assigned to reservation use. Of the vehicles for on-demand use, the vehicle c of model A is in on-demand use and the vehicles d and e are waiting for on-demand use at the time of processing T. The available times of the vehicles d and e are 2.5 hours and 2.0 hours at the time of processing T, respectively. Of the vehicles for reservation use, the vehicles a and b of model A and the vehicles f, g, and i of model B have been reserved, the available time of the vehicle h of model B is 0.5 hours, and the available time of the vehicle j of model B is 6 hours due to cancellation of a reservation at the time of processing T. In this situation, since the available time of the vehicle j of model B is longer than the available times of the vehicles d and e of model A, the control unit 15 switches the vehicle e having a shorter available time out of the vehicles e and d with the vehicle j. When more than one of the vehicles 30 assigned to on-demand use has the same available time, the control unit 15 determines the vehicle 30 to be switched in order of priority such as in predetermined order of priority between or among the models, in ascending order of the downtime set for each model, or in ascending order of the number of other vehicles 30 of each model. When more than one of the vehicles 30 assigned to reservation use has the same available time, the control unit 15 determines the vehicle 30 to be switched in order of priority such as in predetermined order of priority between or among the models, in ascending order of the downtime set for each model, or in ascending order of the number of other vehicles 30 of each model.

The control unit 15 repeats step S508 until the shortest available time of the vehicles 30 waiting in the on-demand waiting area 203 becomes equal to or longer than the longest available time of the vehicles 30 stored in the backyard 201 (No in step S507).

When none of the vehicles 30 stored in the backyard 201 have an available time longer than the available times of the vehicles 30 waiting in the on-demand waiting area 203 (No in step S507), the control unit 15 ends the procedure of FIG. 16A.

By switching the vehicles 30 between the on-demand waiting area 203 and the backyard 201 in this manner, the available times of the vehicles 30 in the on-demand waiting area 203 can always be kept equal to or longer than a certain amount of time, and the opportunity profit from on-demand use can be maximized.

The present disclosure is not limited to the above embodiment. For example, a plurality of blocks shown in the block diagram may be integrated into one block, or a block may be divided into a plurality of sub-blocks. Instead of performing the steps of the flowchart in chronological order according to the description, the steps may be performed in parallel or in a different order either according to the processing capability of the device that performs each step or as necessary. Other modifications can be made without departing from the spirit and scope of the present disclosure.

For example, a part of the processing operation performed by the information processing device 10 in the above embodiment may be performed by the terminal device 20.

For example, a part of the processing operation performed by the terminal device 20 in the above embodiment may be performed by the information processing device 10.

For example, a general-purpose electronic device such as smartphone or computer may be configured to function as the information processing device 10 of the above embodiment. Specifically, programs including the processing content for implementing each function of the information processing device 10 etc. of the embodiment are stored in a memory of the electronic device, and the programs are read and executed by a processor of the electronic device. The disclosure according to the embodiment can also be implemented as a program that can be executed by a processor.

Although an example in which there is a plurality of models of vehicles 30 that can be used for the car sharing service is described in the above embodiment, the number of models of vehicles 30 may be one.

What is claimed is:

1. An information processing device, comprising:
a communication module; and
a processor configured to
send and receive information to and from another device via the communication module, and
in a case where an available time of a second vehicle stored in a storage location is equal to or longer than a reference time when an available time of a first vehicle waiting in an on-demand waiting area becomes shorter than the reference time, send a first command to the first vehicle such that the first vehicle moves to the storage location and send a second command to the second vehicle such that the second vehicle moves to the on-demand waiting area.

2. The information processing device according to claim 1, wherein the processor is configured to send the first command to the first vehicle and send the second command to the second vehicle in a case where the available time of the first vehicle is equal to or longer than the reference time but the available time of the second vehicle has been changed and thus is longer than the available time of the first vehicle.

3. The information processing device according to claim 1, wherein the processor is configured to:
calculate an available time of each model based on a reservation status of each model of a plurality of vehicles stored in the storage location; and
select, as the second vehicle, a vehicle from the vehicles of an available model, the available model being a model with a longer available time than other models.

4. The information processing device according to claim 3, wherein the processor is configured to select the available model on an additional condition that the number of vehicles of this model stored in the storage location is larger than the numbers of vehicles of the other models stored in the storage location.

5. The information processing device according to claim 3, wherein the processor is configured to select the available model on an additional condition that a preset downtime of this model necessary to prepare for use is shorter than preset downtimes of the other models.

6. The information processing device according to claim 3, wherein the processor is configured to select the available model in predetermined order of priority.

7. The information processing device according to claim 3, wherein the processor is configured to select the second vehicle on an additional condition that elapsed time since previous use of the second vehicle is longer than elapsed times since previous use of other vehicles of the available model.

8. The information processing device according to claim 7, wherein the processor is configured to, when the processor does not select the second vehicle, send a third command to a third vehicle such that the third vehicle moves to the on-demand waiting area, the third vehicle being a vehicle that is stored in another storage location and belongs to the available model and elapsed time since previous use of the third vehicle being equal to or longer than the reference time.

9. The information processing device according to claim 8, wherein the processor is configured to stop sending the first command and the second command when the processor does not select the third vehicle.

10. A non-transitory storage medium readable by a computer and storing a program that is executed by a processor to implement the information processing device according to claim 1.

11. An information processing system comprising the information processing device, the first vehicle and the second vehicle according to claim 1.

12. An operation method for an information processing device including a communication module and a processor that sends and receives information to and from another device via the communication module, the operation method comprising, in a case where an available time of a second vehicle stored in a storage location is equal to or longer than a reference time when an available time of a first vehicle waiting in an on-demand waiting area becomes shorter than the reference time, sending a first command from the processor to the first vehicle such that the first vehicle moves to the storage location and sending a second command from the processor to the second vehicle such that the second vehicle moves to the on-demand waiting area.

13. The operation method according to claim 12, further comprising sending the first command from the processor to the first vehicle and sending the second command from the processor to the second vehicle in a case where the available time of the first vehicle is equal to or longer than the reference time but the available time of the second vehicle has been changed and thus is longer than the available time of the first vehicle.

14. The operation method according to claim 12, further comprising:
calculating an available time of each model by the processor based on a reservation status of each model of a plurality of vehicles stored in the storage location; and
selecting, as the second vehicle, a vehicle from the vehicles of an available model by the processor, the available model being a model with a longer available time than other models.

15. The operation method according to claim 14, further comprising selecting the available model by the processor on an additional condition that the number of vehicles of this model stored in the storage location is larger than the numbers of vehicles of the other models stored in the storage location.

16. The operation method according to claim 14, further comprising selecting the available model by the processor on an additional condition that a preset downtime of this model necessary to prepare for use is shorter than preset downtimes of the other models.

17. The operation method according to claim 14, further comprising selecting the available model in predetermined order of priority by the processor.

18. The operation method according to claim 14, further comprising selecting the second vehicle by the processor on an additional condition that elapsed time since previous use of the second vehicle is longer than elapsed times since previous use of other vehicles of the available model.

19. The operation method according to claim 18, further comprising when the processor does not select the second vehicle, sending a third command from the processor to a third vehicle such that the third vehicle moves to the on-demand waiting area, the third vehicle being a vehicle that is stored in another storage location and belongs to the available model and elapsed time since previous use of the third vehicle being equal to or longer than the reference time.

20. The operation method according to claim 19, further comprising stopping sending the first and second commands from the processor when the processor does not select the third vehicle.
